(19) United States
(12) Patent Application Publication
(10) Pub. No.: US 2007/0082676 A1
(43) Pub. Date: Apr. 12, 2007

(54) Method and system to locate a mobile device automatically initiated by the mobile device

(76) Inventors: Kulvir Singh Bhogal, Fort Worth, TX (US); Gregory Jensen Boss, American Fork, UT (US); Rick Allen Hamilton II, Charlottesville, VA (US); Alexandre Polozoff, Bloomington, IL (US)

Correspondence Address: IBM CORPORATION;C/O DARCELL WALKER, ATTORNEY AT LAW, 9301 SOUTHWEST FREEWAY, SUITE 250, HOUSTON, TX, 77074, US

(21) Appl. No.: 11/245,304

(22) Filed: Oct. 6, 2005

(51) Int. Cl. H04Q 7/20

(52) U.S. Cl. 455/456.1

(57) ABSTRACT

The user of a mobile device such as a cellular telephone can locate a lost or misplaced telephone by remotely adjusting the volume of the ring tone such that it is audible enough to for the user to hear it. The user will be able to call his/her own device. Once connected to the device, the user will be provided with the option to remotely change their ringer tone (e.g., from vibrate or low ringer volume to high ringer volume). Another feature is that the device will be able to provide information about its physical location in the event the owner is not in the same proximate area of the device. Third, the device will also have an emergency amount of power reserved exclusively for this retrieval process.

### FEILD OF THE INVENTION

This invention relates to a method and system that locates a potentially lost or misplaced mobile electronic device and in particular to a method and system in which a mobile device automatically detects potential inactivity and contacts the owner of the device and alerts the owner to the location of the mobile device. This invention further relates to a method and system, which includes a battery in the mobile device that has a predetermined amount of capacity in reserve solely to ensure that the system of the present invention will be able to implement the method of the present invention.

### BACKGROUND OF THE INVENTION

The telephone is one of the main means of communication used today. Throughout the world, the telephone provides people, businesses, governmental agencies and virtually all other entities with the capability to instantly communicate with each other. The telephone has evolved from just a device used for verbal/oral communication to a device that is used to transmit video and text messages. In addition, the actual telephone device has changed over time. Some of the original telephones comprised large bases with rotary dials and large hand held pieces through which a person would talk and listen. Today, some telephone designs are one-piece modules through which a person dials numbers, talks and listens. In addition, the communication networks that link different telephones together have also changed. Historically, a telephone network comprised a telephone connected to a central switching box/location. These switching locations were connected through a network of cables. Many of these communication cables were large lines that contained many small communication wires that carried the telephone information. Today, telephone communications are much more sophisticated than the conventional telephone networks. The basic telephone network with a telephone being connected to a switching box does still exist. However, because of the variety of telephones that are in use, there are also other communication network configurations that include the basic telephone network and other communication means.

One reason for the complex communication network is the use of the many different telephones today. A main means of telephone communication today is the over air (wireless) communication. This wireless communication is accomplished through the use of a cellular telephone commonly known as a ‘cell phone’. With this form of communication, there is no physical connection between an individual telephone and a communication switching location. Instead, the telephone communicates over air with a communication tower that directs the call to the desired location. Today, a typical telephone network comprises these communication towers and the conventional switching stations. A person can call a wireless telephone from a conventional telephone. The call will be routed to the conventional switching station. Once it is determined that the called number is a wireless telephone, the call is routed via communication from the switching station to the communication tower for that cellular telephone. The communication then routes the call to the identified number of the cellular telephone.

The loss of cellular telephones and other mobile devices is a significant problem worldwide. In Korea it is estimated that 1 million cellular telephones are annually lost. Tens of thousands of cellular telephones are left in taxicabs yearly according to a nine-nation study of leading taxicab companies. In one study conducted by Gartner Group, they found that 25 to 30 percent of cellular telephones lost in airports are never recovered. In the LAX airport alone, 4800 cellular telephones are collected each year. Continental Airlines also finds about 4800 telephones left behind in their airplanes on an annual basis. Clearly, the loss of cellular telephones is a worldwide problem representing a huge cost to consumers to replace.

When a person misplaces their cellular telephone, a typical way to recover the device is to call its number. The ring tone will give the owner an indication of the telephone location. Although this method works in many situations, the owner must be in the general vicinity of the telephone to hear the ring tone. If the telephone is in another location, this approach will not work. A second drawback to this approach is that many people set the ring tone of the telephone to vibrate or silent. This practice is common so that the ring tone will not disturb other people. If the ring tone is set very low or is not audible, again the owner will not be able to use this traditional approach to locate their misplaced telephone.

In other approaches to recovering a lost telephone, many cell phone users rely on good Samaritans to return their lost telephones. A passerby who finds a phone can turn on the phone and if it does not have a password lock, they can look for owner information if the phone contains it. Otherwise, they can call some people in the address book in an attempt to find the phone's owner. Other methods to locate the phone involve calling the telephone and seeing if anyone answers. If someone does answer and is willing to talk to you the phone might be recovered.

Many times, a cell telephone user knows approximately where they left the phone or at least has a good idea of the location. In this case, the user will return to that location, look around and call the phone to see if they can hear the phone's ring. Several problems with this method occur based on the following preconditions:

Is the telephone turned on?

Does the phone have enough of a charged battery to ring?

Is the telephone in silent or vibrate mode?

Is the telephone's ring tone distinguishable?

What is needed is a better way to assist consumers in recovering their cellular telephones when they become lost. This solution would enable the owner/user to locate a cellular telephone when the ring tone is inaudible and when the telephone is not in the immediate vicinity of the owner. Further, this solution would enable to the telephone device to maintain enough power to operate until found by the owner.

### SUMMARY OF THE INVENTION

It is an objective of the present invention to provide a method and system to enable the owner/user of a cellular telephone to locate a misplaced telephone device.

It is a second objective of the present invention to provide a method and system in which the mobile device will automatically contact its owner to report that it is a lost or inactive device.

It is a third objective of the present invention to provide a device with the capability to reserve an emergency amount of power to be used only for the purpose of locating a device when it has been misplaced.

It is a fourth objective of the present invention to provide a method and system that will enable a misplaced device to determine its physical location and relay that information to the owner/user of the device.

It is a fifth objective of the present invention to provide a device that can only be reactivated by the owner of the device once that device has been found.

The proposed invention aims to provide mobile electronic and computing device users with a capability that will enable the device to identify when it may be lost and to contact the owner with information about its location. The invention provides a method and system in which the mobile device detects when the owner does not know its current location. In method of this invention, the initial triggering parameters are established and input into the device. These parameters serve as indicators that the device may be lost. Once the device has these parameters, the device is set to a monitoring state. In the monitoring state, the device tracks threshold values for the triggering parameters. When the value of a parameter passes the threshold value for that parameter, the monitor detects a trigger event. In response to the detection of this triggering event, the next step is to determine the general physical location of the device. Once the device has determined this location, the device transmits this information to the device owner. After the owner receives this information, the owner can then take steps to locate and retrieve the device.

In another aspect, the present invention relates a system that automatically initiates a process that identifies its physical location and transmits this information to its owner. This system comprises; a program within the device that is capable of monitoring triggering parameters and detecting a triggering event; a program capable of determining physical coordinates corresponding to the general physical location of the device; and a communication network to establish and provide communication between the device and the owner of the device.

In some devices, such as a cellular telephone, the device battery might get drained while the device is lost. Another feature of the invention is to allow for an emergency amount of power which can only be used for device locating and retrieving purposes. The device could then be remotely located via the aforementioned remote finding method and system capabilities.

### DESCRIPTION OF THE DRAWINGS

FIG. 1 is a configuration for a cellular telephone network.

FIG. 2 is a conventional display screen for a cellular telephone device.

FIG. 3 is a conventional keypad for a cellular telephone device.

FIG. 4 is a flow diagram of the basic steps performed by a mobile electronic device in accordance with the present invention.

FIG. 5 is a flow diagram of a specific implementation of the present invention using length of time between charging events as a triggering parameter in accordance with the present invention.

FIG. 6 is a chart of the recent charging history of the device.

FIG. 7 is a flow diagram of the steps to identify the physical location of a misplaced mobile electronic device in accordance with the present invention.

FIG. 8 is a flow diagram of the steps to identify the physical location of a misplaced cellular telephone device in accordance with the present invention.

### DETAILED DESCRIPTION OF THE INVENTION

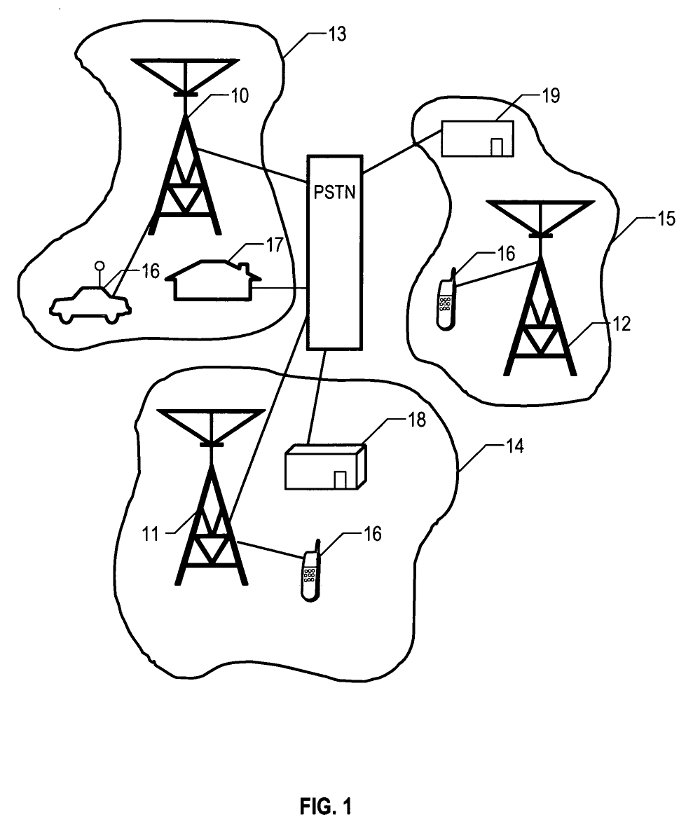

The present invention comprises a method and system for retrieving a portable device such as a cellular telephone when the device is in a mode such that it cannot generate an audible sound to alert the user to its location. The invention further provides features that will enable the portable device to transmit information to the user related to the location of the remote device such that the user can retrieve the device. Referring to FIG. 1, shown is telephone communication network incorporating both wireless and physical connections. Communication towers 10, 11 and 12 provide the connection means for mobile and wireless devices within this network. Each tower has a defined area in which the tower provides wireless telephone connections. As shown, tower 10 serves area 13, tower 11 serves area 14 and tower 12 serves area 15. Within a defined area, the tower will facilitate the connection of wireless devices to the telephone network. This connection will enable a wireless device 16 to connect to other wireless devices or to conventional and stationary devices such as homes 17, factories 18 and office buildings 19. As shown, stationary devices can connect directly to the PSTN (Public Switched Telephone Network). The towers are also connected to the PSTN. This connection enables the wireless device to connect to a stationary device.

The system of the present invention is implemented with the larger communication network shown in FIG. 1. The system of the present invention comprises a wireless telephone communication network that has communication towers such as 10. Each tower has associated software that controls the functioning of the tower. This software receives a call connection attempt, determines the location of the desired number for the connection and makes the call connection.

The system of the present invention incorporates a software module in the communication software that controls the operation of the control tower. This software module of the present invention will monitor the calling activity occurring at the tower. This activity will include the number of wireless calling attempts occurring at that tower. This monitoring process will be on a constant basis. The system of the present invention also comprises the wireless device that is used to make the call attempt. Within the wireless device will be a display to inform the user of the calling availability at that time. Current wireless devices display information that indicates signal strength of a call. The present invention will also provide information on the availability to connect a calling attempt. This information will be in the form of an icon on the display screen of the wireless device.

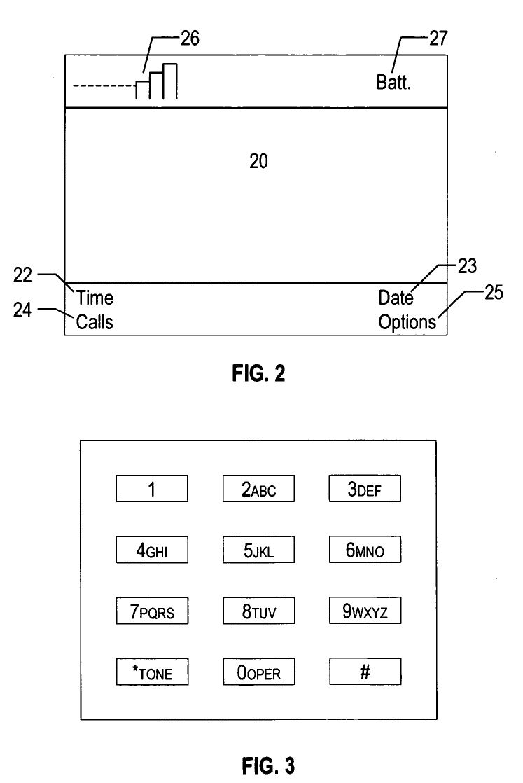

FIG. 2 illustrates a conventional display screen for a wireless calling device. As shown, the device display screen 20 can have information in the form of text data or icons that relay certain standard information. This screen can have an icon that conveys the amount of power available in the battery of the device. The current time 22 and the date 23 can be illustrated with text information. Other icons on the display screen, such as calls 24 and options 25, function in a manner similar to the desktop of a computer screen. Also indicated is the signal strength 26 of a signal coming to the device and the battery strength 27 of the device. As will be discussed later, the battery strength is crucial to the operation of the invention. These icons enable the user to access other options and data on other screen displays within the device. FIG. 3 illustrates the keypad for a wireless device. This keypad is the conventional pad used by touch-tone telephones.

As mentioned, the present invention relates to the capability of a remote device, such as cellular telephone, to automatically initiate device location procedures when it detects the possibility that the owner does not know its location. In this implementation, the device can contact the central system hosted by the carrier to report a “lost” or “deactivated state”. In one scenario, certain trigger parameters can be defined by the device owner that will allow the device to report this critical state. One such trigger parameter could be the length of inactivity. If the cellular telephone device has undergone a period of time of inactivity passed a defined threshold time interval, the telephone could wake up temporarily and notify the system that it might be in a “lost state”. Another such parameter could be length of time between charging. A substantial period without charging will drain the battery. If the battery supply has drained to less than a predefined threshold, this trigger could activate this process. This automatic function would help to notify the owner of a potential dead battery and or lost device before the owner realized that the device was lost. Several other trigger parameters or metrics could be used singularly or combined to arrive at scenario that would trigger the locate process of the present invention. These parameters could include: 1) time the phone has not been used 2) item 1 in combination with historical use data (meaning its unusual that the phone is not used between the hours of 8 AM and 10 AM), 3) lack of movement (perhaps denoted by the implementation of a motion sensor or the lack of changes from registered cell towers) and 4) absence of any key presses over a specified period of time.

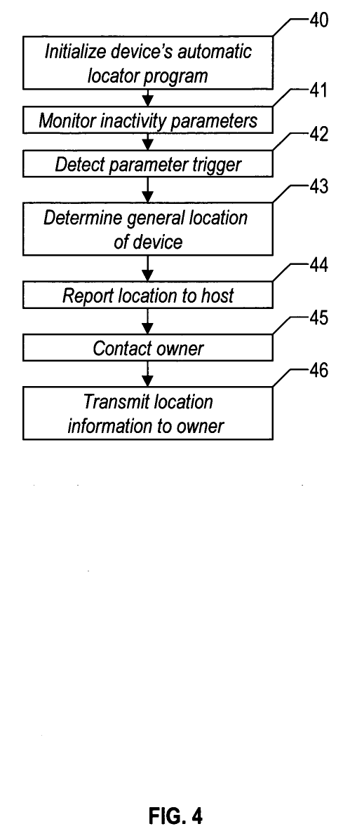

FIG. 4 is a flow diagram of the basic steps performed by a mobile electronic device in accordance with the present invention. Step 40 initializes the device's automatic locator program. After initialization, also in step 41, the program goes into a monitoring state. In this state, the monitor periodically views the triggering parameters to determine whether any of the parameters has crossed its threshold value. As part of the monitoring process, step 42 would detect a triggered parameter. In an alternate embodiment, when a parameter crosses its threshold value, an automatic signal could be broadcast to the method of the present invention. In response to the detection of the triggering of a parameter, step 43 would determine the general or approximate physical location of the device. After the device has determined its physical location, step 44 reports this information to the host (PSTN). It is also possible to establish other procedures by which the owner can directly contact the owner. In step 45, the host contacts the owner. This contact step may be accomplished by having an emergency telephone number for the device owner located at the host. Once contact is made between the host and the device owner, the information related to the physical location of the device is transmitted to the owner in step 46. An alternate mode of communication could be via email. At that time, the owner can then take steps to retrieve the device.

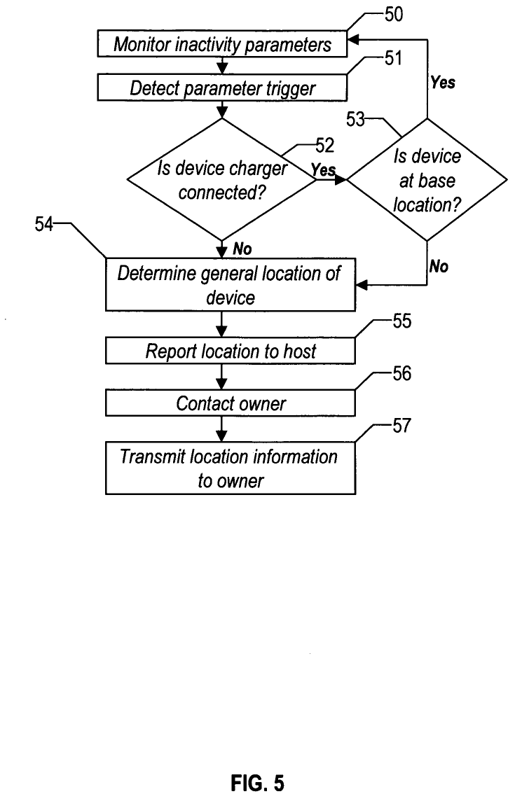

FIG. 5 is a flow diagram of a specific implementation of the present invention using length of time between charging events as a triggering parameter in accordance with the present invention. As with FIG. 4, step 50 monitors the previously identified trigger parameters. Step 51 detects a trigger parameter that has crossed a pre-defined threshold value. The crossing of this threshold value can be considered a triggering event to start the self-locating process of the device. However, the triggering of a certain parameter may not be enough to cause the initiation of the self-locating process. In other cases, the triggering of a certain parameter could be enough to initiate the self-location process. The specific combinations of triggering parameters that will initiate the self-location process will depend on the particular implementation of the process.

In the implementation shown in FIG. 5, two trigger parameters are used to determine whether it is necessary to initiate the self-locating process. After there is a detection of a triggered parameter in step 51, step 52 determines if the triggered parameter is the charger disconnection parameter. This parameter will trigger if the time the charger has been disconnected from the device has exceeded a defined time interval. If the triggering parameter is not the charging parameter (i.e., the device is connected to the charger), the owner may still not know the location of the device. For example, the owner may have left his/her device at their office or at a meeting room or in a hotel room. Therefore, step 53 would then determine if the device is at a base or reference location. This location could probably be the home of the device owner. If the device were at the base location, the process would return to step 50 and continue the monitoring process.

Referring again to step 52, if the charger is not connected, this process moves to step 54 where there is determination of the general location of the device. This step 54 is similar to step 53, but results in the identification of the general location of the device. Step 53 determines whether the device is at a particular location. After the device has determined its general location, step 55 reports this location to the host (PSTN) location. The host then contacts the owner in step 56 and transmits this information to the owner in step 57. The contact with the owner may be through an emergency number that the host can access. In the implementation illustrated in FIG. 5, the charger and the base location parameters serve as the primary parameters that will trigger the self-locating step. Although there may be other trigger parameters, those parameters work in combination with the primary parameters to initiate the self-locating and reporting steps.

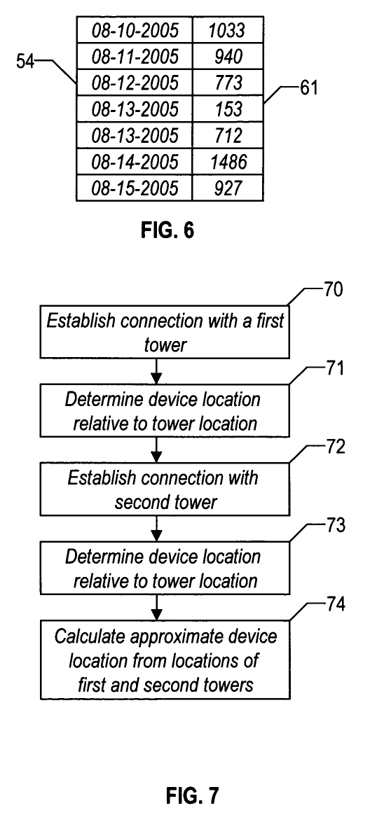

FIG. 6 is a chart of the recent charging history of the device. This chart illustrates the information about the charger trigger parameter that is monitored in step 50. The chart has a column 60 containing the dates of charging events. Column 61 contains the continuous length of time (time interval) in minutes that the device was disconnected from the charger. For example there can be threshold time interval of 1440 minutes. This value represents the number of minutes in a 24-hour day. In this chart, on August 14, the time interval that the device was disconnected from the charger was 1486 minutes. When the time interval crossed the 1440 threshold, step 51 would detect this triggering event as described in FIG. 5.

This process of identifying the general physical location of a lost device has many variations and can use mesh networks and triangulation location techniques to locate the device. FIG. 7 is a flow diagram of the steps in one approach to identify the physical location of a misplaced electronic device in accordance with the present invention. This approach uses multiple communication towers 10, 11 and 12 (See FIG. 1) to help determine the physical location. The towers are useful in part because they have a known physical location. In step 70, the device connects with the first tower. Step 71 determines a location of the device relative to the first tower. In step 72, the device connects to the second communication tower. Step 73 determines the location of the device relative to the second tower. With this information, step 74 can determine a general physical location of the device relative to the locations of the communication towers.

With regard to a cellular telephone, one approach involves using nearby telephones to help lead an owner to his/her lost telephone. In such an implementation where the telephone is known or believed to be lost the telephone could broadcast its coordinates to a centrally hosted system (by the cellular carrier) that would release that information to the owner after logging into the system. Coordinate information could be mapped to well known electronic maps and an address could be derived from said information. The coordinates that the phone transmits could be based on either a triangulation of registered cell towers and related signal strengths or via GPS coordinates as some phones are beginning to have. Alternatively, a phone which is in a “Auto Locate” state could broadcast by means of Bluetooth or other radio/wireless means a signal to other nearby phones which would in succession allow an owner to follow the audible bread crumb to his lost phone.

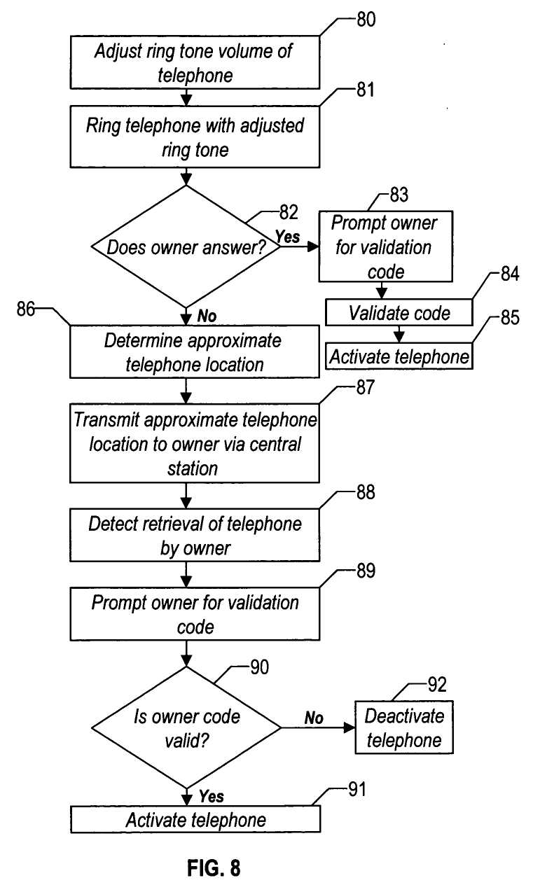

Referring to FIG. 1, there are situations when the owner may be at home 17, but has left their telephone in office building 19. FIG. 8 illustrates the steps to identify the physical location of a misplaced cellular telephone device. The physical identification along with the adjusted ring tone will increase the ability of the owner to locate a misplaced telephone.

After there has been an identification of the telephone location, the owner can then locate and retrieve the device. The process begins with the adjustment of the ring tone volume. In step 80, the user can adjust the ring tone volume in the event the telephone is in an inaudible state. Next the owner calls the telephone device in step 81. Step 82 determines whether there is an answer of the called telephone. If someone does answer, this means that the telephone was heard. At this point, steps 83, 84 and 85 verify that the one answering the telephone is the owner of the telephone. Step 83 prompts for the owner validation code. Again this code will be unique for the owner. Once the code is input into the telephone, step 84 validates this code against the known code of the owner. If the inputted code matches the owner code for that telephone, step 85 activates the telephone such that the owner can use the telephone in a normal manner. It is necessary to activate the telephone for security purposes. The activation of the Voice Response Unit (VRU) in FIG. 6 causes the telephone to go into a security state. This activation informs the telephone that the owner is looking for it. . In addition to the ring tone, the mobile device can also exhibit a visual indicator such as a flashing battery. This visual indicator can be of more importance in environments having little light. In step 82, anyone can answer the telephone. However, it is necessary to ensure that the one answering the telephone is the telephone's owner. Therefore, before the telephone returns to normal operations, it is necessary to deactivate the voice recovery mode of the telephone.

Referring again to step 82, if no one answers the telephone, the telephone interprets this as a lost telephone at a location that is not in the proximity of the owner. As a result, the telephone will attempt to identify its location and send that information to the owner. Step 86 determines the approximate physical location of the telephone. One specific implementation to physically identify a telephone location is the use of Mesh Network and Triangulation Location Techniques. This approach involves using nearby telephones or telephone towers to help lead a user to his lost phone. In such an implementation where the telephone is known or believed to be lost, the phone could broadcast its coordinates to a centrally hosted system (i.e., the cellular carrier) that would release that information to the owner after logging into the system. Coordinate information could be mapped to well known electronic maps and an address could be derived from said information. The coordinates that the telephone transmits could be based on either a triangulation of registered cell towers 10, 11 and 12 and related signal strengths or via GPS coordinates as some phones are beginning to have. Alternatively, a phone which is in a “Auto Locate” state could broadcast by means of Bluetooth or other radio/wireless means a signal to other nearby phones which would in succession allow an owner to follow the audible bread crumb to his lost phone.

Referring again to step 86, once there has been a determination of the telephone location, this information is transmitted to the owner via a central station in step 87. This process could be in the form of a telephone call to the owner. In step 88, the telephone would detect its retrieval. This detection could be by the calling the telephone, then answering it. At this point, it is necessary to validate that the person answering the telephone is the owner. Step 89 will prompt for the owner validation code. Step 90 determines if this code is correct. This determination could be by comparing the inputted code to the known code of the owner. If the codes match, the validation is complete. At this point, step 91 activates the telephone similar to step 85. If the codes do not match, step 92 keeps the telephone in the deactivated state that it entered when the volume adjustment process began in step 80. As previously discussed, this deactivated state is in regard to normal use of the telephone. In an example, a telephone located in office building 19 is closest to tower 12. This determination could be based on signal strength of the telephone to the tower. From this information, the user may realize that the tower is generally near the office building. At that point, the owner can go to the office building, call the telephone device and with the adjusted ring tone hear and retrieve the telephone. As previously mentioned, the mobile device can also exhibit a visual indicator such as a flashing battery. This visual indicator can be of more importance in environments having little light.

With any implementation of the device of the present invention, the device has to have power. When a telephone is lost for a significant period of time, the battery charge will be depleted. Part of the invention includes additional functionality be added to the cell phone. Two major changes/additions are needed. The first change is the ability to reserve a certain amount of battery power that can only be used during an “auto Locate” state change. This reserve battery supply could be implemented electronically or by using separate battery supplies. Electronic reserves can be accomplished by displaying a zero percent battery indication when there is in fact 2% in reserve. At that point the phone could be forced off and normal indications to the user would be that the phone was indeed out of power. The amount of battery power that is held in reserve could be a user defined setting on the phone. Optionally, a second smaller reserve battery could be installed just for this purpose.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

I claim:

1. A method for automatically determining the location of an electronic device and transmitting that location to the device owner, the method comprising the steps of:
establishing one or more trigger parameters that may indicate when an owner does not know the location of the device;
establishing conditions for initiating a step to determine the physical location of the device, the conditions being based on the state of one or more trigger parameters;
detecting the triggering of a trigger parameter;
determining whether an established condition for initiating a step to determine the physical location of the device is present based on the detection of the triggered parameter; determining a general physical location of the device when the determination is that an established condition is met and
transmitting the determined physical location to the device owner.

2. The method as described in claim 1 wherein said trigger parameter establishing step further comprises identifying a threshold value for each identified trigger parameter.

3. The method as described in claim 2 wherein said trigger event detection step further comprises identifying when a trigger parameter has exceeded the threshold value for that trigger parameter.

4. The method as described in claim 3 further comprising the step of determining whether the detection of a trigger event meets the established conditions for initiating said general physical location determining step.

5. The method as described in claim 1 wherein trigger parameters comprise primary trigger parameters and secondary parameters.

6. The method as described in claim 5 wherein said primary trigger parameters comprise:
time interval the device is not connected to a power charger; and
time interval the device is not at a defined base location.

7. The method as described in claim 4 wherein said step of determining whether the detection of a trigger event meets the conditions for initiating said general physical location determining step comprises:
detecting whether a charger trigger parameter has exceeded the threshold for that parameter;
detecting whether a base location trigger parameter has exceeded the threshold for that parameter when the charger trigger parameter has not exceeded its threshold; and
continuing to monitor trigger parameters when the base location parameter has not exceeded its threshold value.

8. The method as described in claim 4 wherein said step of determining whether the detection of a trigger event meets the conditions for initiating said general physical location determining step comprises:
detecting whether the charger trigger parameter has exceeded the threshold for that parameter;
detecting whether the base location trigger parameter has exceeded the threshold for that parameter when the charger trigger parameter has not exceeded its threshold; and
initiating said determining a general physical location of the device when the base location parameter has exceeded its threshold value.

9. The method as described in claim 4 wherein said step of determining whether the detection of a trigger event meets the conditions for initiating said general physical location determining step comprises:
detecting whether a charger trigger parameter has exceeded the threshold for that parameter; and
initiating said determining a general physical location of the device when the charger trigger parameter has exceeded its threshold value.

10. The method as described in claim 1 wherein said determining a general physical location of the device step further comprises the steps of:
establishing a connection with one or more communication towers;
determining location coordinates for the device in relation to the first communication tower;
calculating a general physical location of the device in relation to the determined location coordinates of the one or more communication towers.

11. The method as described in claim 1 wherein said determining a general physical location of the device step further comprises the steps of:
establishing a connection with a first communication tower;
determining location coordinates for the device in relation to the first communication tower;
establishing a connection with a second communication tower;
determining location coordinates for the device in relation to the second communication tower; and
calculating a general physical location of the device in relation to the first and second communication towers.

12. The method as described in claim 1 further comprising after said information transmitting step, the step maintaining an operational history of the trigger parameters.

13. The method as described in claim 12 wherein said maintaining step further comprises updating the operational history of the trigger parameters after the detection of a triggering event.

14. The method as described in claim 1 wherein said transmitting the determined physical location to the owner is performed using electronic mail.

15. A method for automatically determining the location of an electronic device and transmitting that location to the device owner, the method comprising the steps of:
defining a power level threshold for a battery contained in the device;
monitoring the power level of a battery in the device;
detecting when the power level of the battery has dropped below the defined power level threshold;
determining a general physical location of the device when the power level of the battery has dropped below the defined power level threshold; and
transmitting the determined physical location to the device owner.

16. The method as described in claim 1 wherein said determining a general physical location of the device step further comprises the steps of:
establishing a connection with one or more communication towers;
determining location coordinates for the device in relation to the first communication tower;
calculating a general physical location of the device in relation to the determined location coordinates of the one or more communication towers.

17. A computer program product in a computer readable medium for automatically determining the location of an electronic device and transmitting that location to the device owner comprising:
instructions for establishing one or more trigger parameters that may indicate when an owner does not know the location of the device;
instructions for establishing conditions for initiating a step to determine the physical location of the device, the conditions being based on the state of one or more trigger parameters;
instructions for detecting the triggering of a trigger parameter;
instructions for determining whether an established condition for initiating a step to determine the physical location of the device is present based on the detection of the triggered parameter;
instructions for determining a general physical location of the device when the determination is that an established condition is met and
instructions for transmitting the determined physical location to the device owner.

18. The computer program product as described in claim 17 wherein determining a general physical location of the device instructions further comprise:
instructions for establishing a connection with one or more communication towers;
instructions for determining location coordinates for the device in relation to the first communication tower;
instructions for calculating a general physical location of the device in relation to the determined location coordinates of the one or more communication towers.

19. The computer program product as described in claim 17 further comprising after said information transmitting instructions, instructions for maintaining an operational history of the trigger parameters

20. The computer program product as described in claim 19 wherein said maintaining instructions further comprise instructions for updating the operational history of the trigger parameters after the detection of a triggering event.
